(19) United States
(12) Patent Application Publication
(10) Pub. No.: US 2023/0069528 A1
(43) Pub. Date: Mar. 2, 2023

(54) EXHAUST DEVICE FOR SHIP PROPULSION MACHINE

(71) Applicant: SUZUKI MOTOR CORPORATION, Hamamatsu-shi (JP)

(72) Inventor: Jun ITO, Hamamatsu-shi (JP)

(73) Assignee: SUZUKI MOTOR CORPORATION, Hamamatsu-shi (JP)

(21) Appl. No.: 17/896,741

(22) Filed: Aug. 26, 2022

(30) Foreign Application Priority Data
Aug. 30, 2021 (JP) 2021-139810

(51) Int. Cl. B63H 20/24; F01N 3/28; F01N 13/14

(52) U.S. Cl. CPC B63H 20/24; F01N 3/2803; F01N 13/14

(57) ABSTRACT

An exhaust device discharging exhaust gas from an engine of a ship propulsion machine includes an exhaust passage through which the exhaust gas flows and a catalyst device purifying the exhaust gas. The exhaust passage includes a first exhaust pipe and a second exhaust pipe connected to an outflow side of the first exhaust pipe. The catalyst device includes a metal catalyst including a metal catalyst carrier, an outer shell portion having a tubular shape and accommodating the metal catalyst, and a holding portion provided in the outer shell portion, having a brim shape protruding radially outward beyond an outer circumferential surface of the outer shell portion, and holding the catalyst device. The catalyst device is held in the exhaust passage by the holding portion being sandwiched between an outflow-side end portion of the first exhaust pipe and an inflow-side end portion of the second exhaust pipe.

### CROSS-REFERENCE TO RELATED APPLICATIONS

The disclosure of Japanese Patent Application No. 2021-139810 filed on Aug. 30, 2021, including specification, drawings and claims is incorporated herein by reference in its entirety.

### BACKGROUND

The present invention relates to an exhaust device fora ship propulsion machine.

A catalyst device that purifies exhaust gas of an engine (internal combustion engine) is provided in an exhaust passage of a ship propulsion machine by the engine as a power source. The catalyst device includes a catalyst that reduces harmful components contained in the exhaust gas of the engine. The catalyst is formed by supporting a noble metal such as platinum and palladium on a honeycomb-shaped carrier.

A metal catalyst including a carrier made of a metal or a ceramic catalyst including a carrier made of a ceramic is often adopted as a catalyst device provided in a ship propulsion machine. The metal catalyst is more expensive than the ceramic catalyst but has high impact resistance.

Patent Literature 1 below describes an exhaust device of an outboard motor with a metal catalyst. As shown in FIGS. 1 to 3 of Patent Literature 1, the exhaust device described in Patent Literature 1 includes an exhaust manifold (35A) that collects exhaust gas. The exhaust manifold (35A) is connected to an outlet (36) of each exhaust port of the engine (5). A catalyst (42) with a metal honeycomb as a carrier is provided in a second exhaust passage (40A) constituting a part of the exhaust manifold (35A). The catalyst (42) is press-fitted into the second exhaust passage (40A) in a state in which a heat insulating material (45) with a mat shape is wound around a periphery of the catalyst (42).
Patent Literature 1: JP-A-2008-169707

### SUMMARY

The present invention provides an exhaust device configured to discharge exhaust gas from an engine of a ship propulsion machine. The exhaust device includes: an exhaust passage through which the exhaust gas flows; and a catalyst device provided in the exhaust passage and configured to purify the exhaust gas, in which the exhaust passage includes a first exhaust pipe, and a second exhaust pipe connected to an outflow side of the first exhaust pipe, in which the catalyst device includes a metal catalyst including a catalyst carrier made of metal, an outer shell portion having a tubular shape and accommodating the metal catalyst therein, and a holding portion provided in the outer shell portion, having a brim shape protruding radially outward beyond an outer circumferential surface of the outer shell portion, and configured to hold the catalyst device in the exhaust passage, and in which the catalyst device is held in the exhaust passage by the holding portion being sandwiched between an outflow side end portion of the first exhaust pipe and an inflow side end portion of the second exhaust pipe.

### BRIEF DESCRIPTION OF DRAWINGS

FIG. 1 is an illustration view illustrating an outboard motor including an exhaust device according to an embodiment of the present invention.

FIG. 2 is a perspective view illustrating an engine holder and an engine provided with the exhaust device according to the embodiment of the present invention.

FIG. 3 is a cross-sectional view illustrating the exhaust device according to the embodiment of the present invention, a part of which is removed to expose the inside of the exhaust device.

FIG. 4 is a cross-sectional view illustrating a lower end portion of an outflow pipe portion of an exhaust manifold, an upper end portion of a collector, and a catalyst device in the exhaust device in FIG. 3.

FIG. 5 is a cross-sectional view illustrating a part of a protruding portion of a bracket, which is sandwiched between the lower end portion of the outflow pipe portion and the upper end portion of the collector, in the catalyst device of the exhaust device in FIG. 4.

FIG. 6 is a cross-sectional view illustrating a modification of the catalyst device according to the embodiment of the present invention.

### DESCRIPTION OF EMBODIMENTS

During operation of the engine, a vibration of the engine is applied to the catalyst provided in the exhaust passage. In addition, when the ship rides over a wave and lands on the water during sailing, or when the ship repeats a small jump during gliding, an impact due to a collision between the ship and a water surface is applied to the catalyst. It is necessary to hold the catalyst in a stable state in the exhaust passage so as to prevent the catalyst from being displaced or falling off in the exhaust passage due to such vibration or impact.

In this regard, in the exhaust device described in Patent Literature 1, the metal catalyst is held in the second exhaust passage by being press-fitted into the second exhaust passage in a state in which a heat insulating material is wound around the metal catalyst.

When a case where the metal catalyst wrapped with the heat insulating material is press-fitted into the exhaust passage is compared with a case where a ceramic catalyst wrapped with a heat insulating material is press-fitted into an exhaust passage, a friction coefficient of the metal catalyst in contact with the heat insulating material is smaller than a friction coefficient of the ceramic catalyst in contact with the heat insulating material. Therefore, the holding force for holding the catalyst in the exhaust passage tends to be smaller in the case where the metal catalyst wrapped with the heat insulating material is press-fitted into the exhaust passage than that in the case where the ceramic catalyst wrapped with the heat insulating material is press-fitted into the exhaust passage. Therefore, as in the exhaust device described in Patent Literature 1, the metal catalyst is only held by being press-fitted into the second exhaust passage, and in this case, it is difficult to ensure a holding force capable of resisting the vibration and the impact, and the catalyst may be displaced or fall off due to the vibration and the impact.

Further, even if the holding force capable of resisting the vibration and the impact can be ensured by the method of press-fitting and holding the metal catalyst in the exhaust passage at the beginning of the production of the ship propulsion machine, the holding force capable of resisting the vibration and the impact cannot be maintained for a long period of time due to aging deterioration of the heat insulating material or the like wound around the metal catalyst.

The present invention has been made in view of, for example, the above-described problems, and an object of the present invention is to provide an exhaust device fora ship propulsion machine, which can improve holding stability when a metal catalyst is held in an exhaust passage.

According to the present invention, when the metal catalyst is held in the exhaust passage, the holding stability can be improved.

An exhaust device according to an embodiment of the present invention is an exhaust device for discharging exhaust gas from an engine of a ship propulsion machine, and includes an exhaust passage through which the exhaust gas flows and a catalyst device for purifying the exhaust gas.

In the exhaust device, the exhaust passage includes a first exhaust pipe and a second exhaust pipe connected to an outflow side of the first exhaust pipe.

In the exhaust device, the catalyst device is provided in the exhaust passage. In addition, the catalyst device includes a metal catalyst including a catalyst carrier made of a metal, an outer shell portion formed in a tubular shape and accommodating the metal catalyst therein, and a holding portion for holding the catalyst device in the exhaust passage.

The holding portion is provided in the outer shell portion (for example, joined or integrally formed), and is formed in a brim shape protruding radially outward beyond an outer circumferential surface of the outer shell portion. Further, the catalyst device is held in the exhaust passage by the holding portion sandwiched between an outflow-side end portion of the first exhaust pipe and an inflow-side end portion of the second exhaust pipe.

In the exhaust device of the present embodiment, the catalyst device is held in the exhaust passage by the holding portion sandwiched between the outflow-side end portion of the first exhaust pipe and the inflow-side end portion of the second exhaust pipe. Therefore, a holding force for holding the catalyst device in the exhaust passage can be increased, and the holding stability to hold the catalyst device in the exhaust passage can be improved, as compared with a case where a catalyst device is only press-fitted into an exhaust passage in a state in which a heat insulating material is wound around a periphery of the catalyst device.

### EMBODIMENT

Hereinafter, an embodiment of the exhaust device of the present invention will be described. In the description of the embodiment, the up (Ud), down (Dd), front (Fd), back (Bd), left (Ld), and right (Rd) directions follow arrows drawn at a lower right portion of each drawing.

(Outboard Motor)

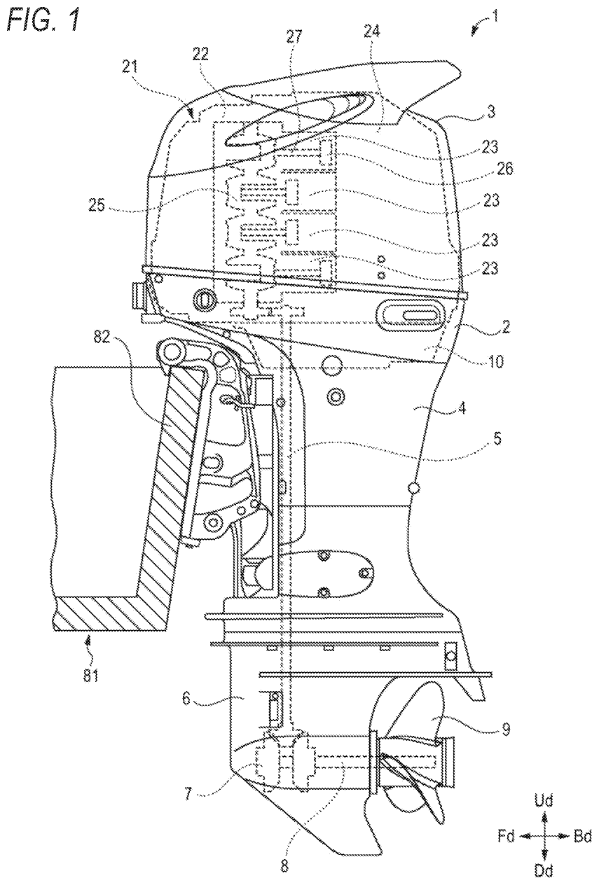

FIG. 1 illustrates an outboard motor 1 including an exhaust device according to an embodiment of the present invention. The outboard motor 1 is a device for generating a propulsive force for a ship, and is a form of a ship propulsion machine. As illustrated in FIG. 1, the outboard motor 1 is attached to a transom 82 provided at a stern of a ship 81.

An upper portion of the outboard motor 1 is provided with an engine holder 10, and an engine 21 as a power source of the outboard motor 1. The engine 21 is mounted on the engine holder 10. The engine holder 10 and a lower portion of the engine 21 are covered with a bottom cowling 2, and an upper portion of the engine 21 is covered with a top cowling 3. A drive shaft 5 for transmitting power of the engine 21 to a propeller shaft 8 is provided in an upper casing 4 provided below the bottom cowling 2. A gear mechanism 7 for transmitting rotation of the drive shaft 5 to the propeller shaft 8 and the propeller shaft 8 that is a rotation shaft of a propeller 9 are provided in a lower casing 6 provided below the upper casing 4. The propeller 9 is attached to a rear end portion of the propeller shaft 8.

(Engine)

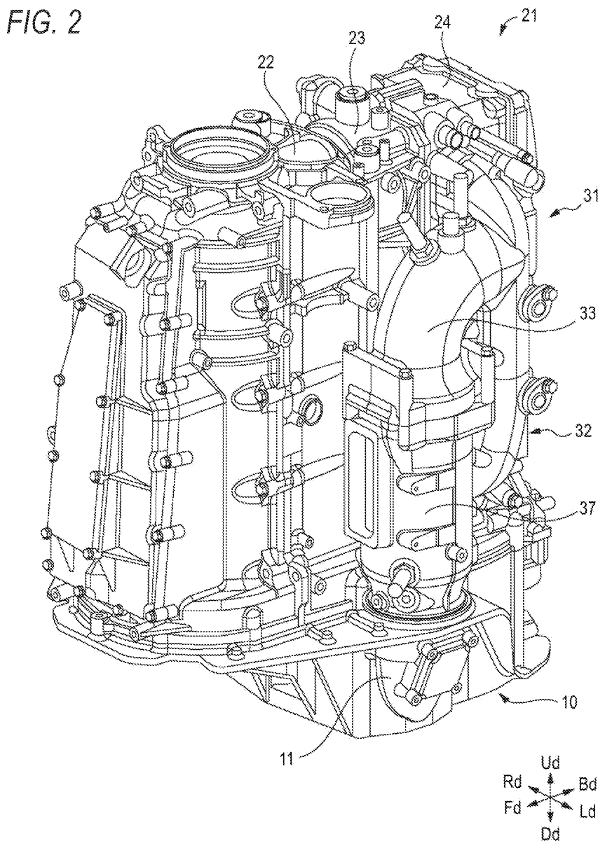

FIG. 2 illustrates the engine holder 10 and the engine 21 provided with an exhaust device 31 according to the embodiment of the present invention. The engine 21 is a four-cycle engine operating by gasoline as a fuel. As illustrated in FIG. 2, the engine 21 includes a crankcase 22 provided in a front portion thereof, and, for example, four cylinders 23 provided behind the crankcase 22. The four cylinders 23 each extend in a front-back direction and are arranged side by side in an up-down direction. A cylinder head 24 is provided behind the cylinders 23. As schematically illustrated in FIG. 1, a crankshaft 25 extending in the up-down direction is provided in the crankcase 22. A piston 26 is provided in each of the cylinders 23, and each piston 26 is connected to the crankshaft 25 via a connecting rod 27. The crankshaft 25 is connected to the drive shaft 5.

Although not illustrated, the cylinder head 24 is provided with, for each cylinder 23, an intake port for feeding a mixture of air and gasoline into the cylinder 23, an exhaust port for discharging burned gas in the cylinder 23 as exhaust gas to an outside of the cylinder 23, an intake valve for opening or closing the intake port, an exhaust valve for opening or closing the exhaust port, a spark plug for igniting the mixture, and the like. Further, a valve operating mechanism for controlling opening and closing of each intake valve and each exhaust valve is provided in the cylinder head 24.

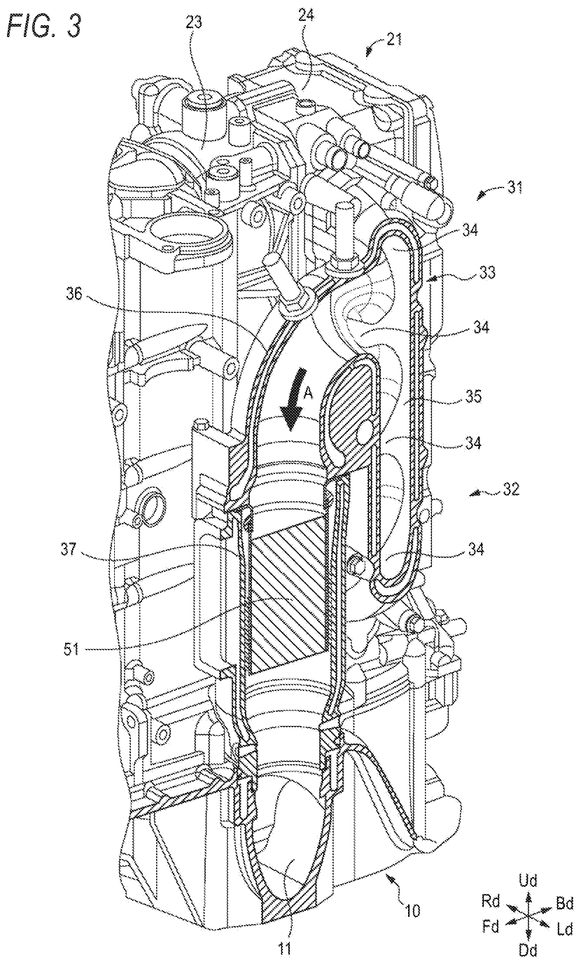

(Exhaust Device) FIG. 3 illustrates the exhaust device 31. In FIG. 3, a left portion of the exhaust device 31 is removed to expose an inside of the exhaust device 31. The exhaust device 31 is a device for discharging exhaust gas from the engine 21 and includes an exhaust passage 32 through which the exhaust gas flows, and a catalyst device 51 for purifying the exhaust gas, as illustrated in FIG. 3. The exhaust device 31 in the present embodiment is disposed on a left side of the engine 21. An arrow A in FIG. 3 indicates a direction in which the exhaust gas flows.

(Exhaust Passage)

The exhaust passage 32 includes an exhaust manifold 33 as a first exhaust pipe and a collector 37 as a second exhaust pipe. The exhaust manifold 33 and the collector 37 are both made of an aluminum alloy. Each of the exhaust manifold 33 and the collector 37 has a double cylinder structure.

The exhaust manifold 33 includes four (the same number as the number of cylinders) inflow pipe portions 34, a merging portion 35, and a single outflow pipe portion 36. Each of the inflow pipe portions 34 is formed on an inflow side of the exhaust manifold 33 into which the exhaust gas flows. The outflow pipe portion 36 is formed on an outflow side of the exhaust manifold 33 from which the exhaust gas flows out. The merging portion 35 is formed between the four inflow pipe portions 34 and the outflow pipe portion 36 in the exhaust manifold 33.

The four inflow pipe portions 34 are arranged side by side in the up-down direction, and inflow ports of the inflow pipe portions 34 are connected to outflow ports of the four exhaust ports, respectively. The outflow sides of the inflow pipe portions 34 each communicate with the merging portion 35.

As illustrated in FIG. 3, the outflow pipe portion 36 is formed in a cylindrical shape, and extends forward from a front portion on an upper side of the merging portion 35, then gently curves downward, and then extends downward. An outflow port of the outflow pipe portion 36 is open downward.

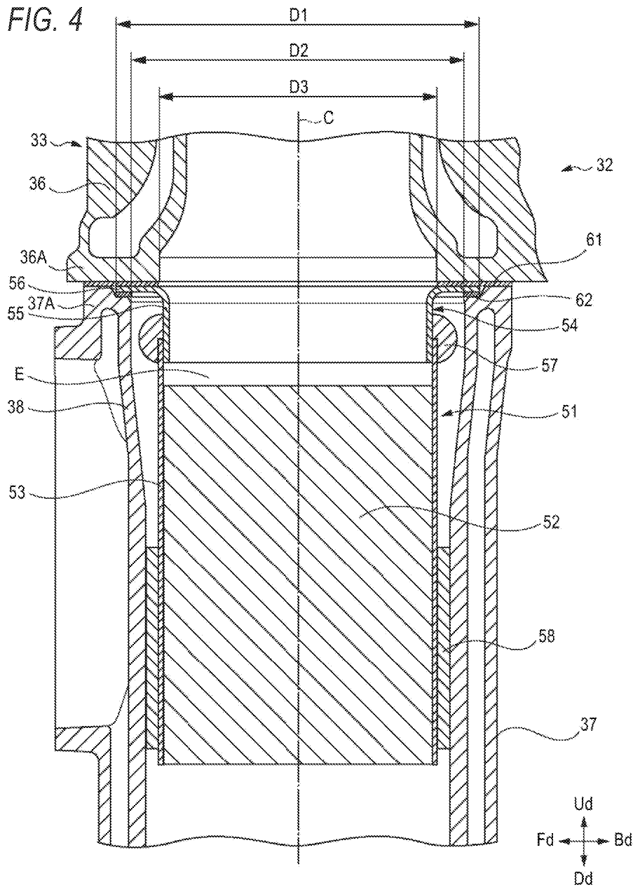

The collector 37 is connected to the outflow side of the exhaust manifold 33. Specifically, an inflow port of the collector 37 is connected to the outflow port of the outflow pipe portion 36, and accordingly, an inside of the outflow pipe portion 36 and an inside of the collector 37 communicate with each other. An upper end surface of the collector 37 faces a lower end surface of the outflow pipe portion 36 (see FIG. 4). The collector 37 is formed in a cylindrical shape and linearly extends in the up-down direction.

An outflow port of the collector 37 is connected to an inflow port of an exhaust gas lead-out hole 11 formed in the engine holder 10. Although not illustrated, an outflow side of the exhaust gas lead-out hole 11 is connected to a discharge passage provided in the outboard motor 1. The discharge passage extends in the up-down direction inside the upper casing 4 and the lower casing 6 of the outboard motor 1, and a lower end of the discharge passage reaches a vicinity of the propeller shaft 8. The propeller 9 is provided with a release passage for releasing the exhaust gas carried through the exhaust passage into the water.

(Catalyst Device)

FIG. 4 is an enlarged view of a lower end portion of the outflow pipe portion 36 of the exhaust manifold 33, an upper end portion of the collector 37, and the catalyst device 51 in FIG. 3. As illustrated in FIG. 4, the catalyst device 51 is provided in the exhaust passage 32, specifically, in the collector 37. The catalyst device 51 includes a metal catalyst 52, an outer shell portion 53 in which the metal catalyst 52 is accommodated, and a bracket 54 as a holding portion for holding the catalyst device 51 in the exhaust passage 32.

The metal catalyst 52 has a function of reducing harmful components contained in the exhaust gas of the engine 21. The metal catalyst 52 is formed by supporting a noble metal such as platinum and palladium on a catalyst carrier formed in a honeycomb shape from steel such as stainless steel. The metal catalyst 52 has a cylindrical outer shape.

The outer shell portion 53 is formed in a cylindrical shape from steel such as stainless steel. An inner diameter of the outer shell portion 53 is set to a value substantially equal to an outer diameter of the metal catalyst 52 so that a gap is not formed between an inner circumferential surface of the outer shell portion 53 and an outer circumferential surface of the metal catalyst 52 accommodated in the outer shell portion 53. An outer diameter of the outer shell portion 53 is set to a value smaller than an inner diameter of the collector 37 so that the outer shell portion 53 accommodating the metal catalyst 52 can be accommodated in the collector 37. A length of the outer shell portion 53 is larger than a length of the metal catalyst 52 and shorter than a length of the collector 37. The metal catalyst 52 is disposed at a lower end side position of the outer shell portion 53, and an empty region E in which the metal catalyst 52 is not present is formed in an upper end side portion of the outer shell portion 53.

The bracket 54 is made of the same material as that of the outer shell portion 53. The bracket 54 includes a tubular portion 55 and a protruding portion 56.

The tubular portion 55 is formed in a cylindrical shape. An outer diameter of the tubular portion 55 is set to a value substantially equal to the inner diameter of the outer shell portion 53. Strictly speaking, the outer diameter of the tubular portion 55 is set to a value slightly smaller than the inner diameter of the outer shell portion 53 so that a lower end side portion (a portion on the other axial end side) of the tubular portion 55 enters the outer shell portion 53.

The protruding portion 56 protrudes radially outward from an upper end side portion (a portion on one axial end side) of the tubular portion 55. The protruding portion 56 protrudes radially outward beyond an outer circumferential surface of the outer shell portion 53. The protruding portion 56 is formed in a brim shape or a flange shape over the entire circumference of the tubular portion 55. As shown in FIG. 4, an outer diameter D1 of the protruding portion 56 is larger than an inner diameter D2 of an upper end portion 37A of the collector 37 and larger than an inner diameter D3 of a lower end portion 36A of the outflow pipe portion 36.

The bracket 54 is joined to the upper end side portion (inflow end side portion) of the outer shell portion 53. Specifically, the lower end side portion of the tubular portion 55 is inserted into an upper portion (inflow side portion) of the outer shell portion 53 from an upper side (inflow side) of the outer shell portion 53, and the lower end side portion of the tubular portion 55 and the upper end side portion of the outer shell portion 53 are welded to each other. The tubular portion 55 is welded to the upper end side portion of the outer shell portion 53 in a state in which an outer circumferential surface of the lower end side portion of the tubular portion 55 is in contact with the inner circumferential surface of the outer shell portion 53. In addition, an inner circumferential surface of the lower end side portion of the tubular portion 55 is closer to an axis C of the outer shell portion 53 than an inner circumferential surface of an upper portion of the outer shell portion 53. In FIG. 4, reference numeral 57 denotes a welded portion at which the tubular portion 55 and the outer shell portion 53 are joined to each other.

The catalyst device 51 having such a configuration is inserted into the collector 37 via a heat insulating material 58. That is, the heat insulating material 58 is provided between an outer circumferential surface of a lower portion (outflow side portion) of the outer shell portion 53 and an inner circumferential surface of the collector 37. The heat insulating material 58 is mainly made of, for example, inorganic fibers such as aluminum oxide fibers (alumina fibers), and is formed in a mat shape.

During the production or maintenance of the exhaust device 31, the catalyst device 51 is press-fitted into the collector 37 from an upper side (one axial side) of the collector 37 after the heat insulating material 58 is wound around the outer shell portion 53. In order to facilitate the press-fitting operation of the catalyst device 51, an enlarged diameter portion 38 is formed in an upper portion (a portion on one axial side) of the collector 37. The enlarged diameter portion 38 is gradually enlarged in diameter in a direction from a lower side (the other axial side) of the collector 37 toward an upper side (one axial side).

The catalyst device 51 is held in the collector 37 by being press-fitted into the collector 37 in a state in which the heat insulating material 58 is wound around the outer shell portion 53. In addition, the catalyst device 51 is held in the collector 37 by the protruding portion 56 of the bracket 54 being sandwiched between the lower end portion 36A (outflow-side end portion) of the outflow pipe portion 36 of the exhaust manifold 33 and the upper end portion 37A (inflow-side end portion) of the collector 37.

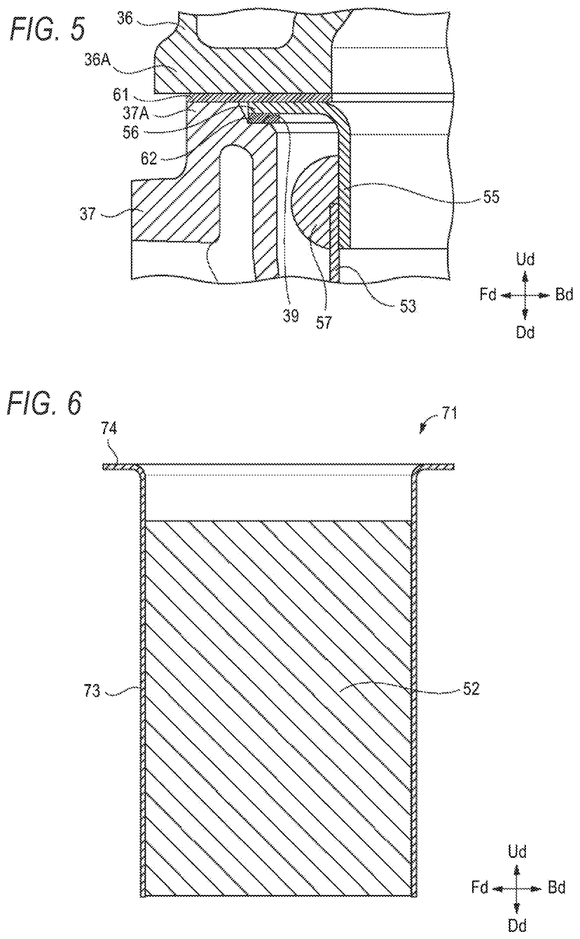

FIG. 5 is an enlarged view of a portion of the catalyst device 51 in FIG. 4 where the protruding portion 56 of the bracket 54 is sandwiched between the lower end portion 36A of the outflow pipe portion 36 and the upper end portion 37A of the collector 37. As illustrated in FIG. 5, a step portion 39 is formed on the upper end surface of the collector 37 over the entire circumference of the collector 37 such that an inner circumferential side portion of the collector 37 is lower than an outer circumferential portion thereof. The protruding portion 56 of the bracket 54 is held between the lower end surface of the outflow pipe portion 36 and a lower portion of the upper end surface of the collector 37 on the inner circumferential side.

An upper joint sheet 61 formed in an annular thin plate shape by an insulating material is provided between the lower end surface of the outflow pipe portion 36 and an upper surface of the protruding portion 56 of the bracket 54. The upper joint sheet 61 has a function of insulating the outflow pipe portion 36 and the bracket 54, which are formed of mutually different metals, from each other, and preventing electric corrosion of the outflow pipe portion 36 or the bracket 54 (mainly the outflow pipe portion 36 made of an aluminum alloy). The upper joint sheet 61 is a specific example of a first insulating member.

A lower joint sheet 62 formed of an insulating material in an annular thin plate shape is provided between a lower surface of the protruding portion 56 of the bracket 54 and the lower portion of the upper end surface of the collector 37 on the inner circumferential side. The lower joint sheet 62 has a function of insulating the bracket 54 and the collector 37, which are formed of mutually different metals, from each other, and preventing electric corrosion of the bracket 54 or the collector 37 (mainly the collector 37 made of an aluminum alloy). As the upper joint sheet 61 and the lower joint sheet 62, for example, a paper gasket can be used. The lower joint sheet 62 is a specific example of a second insulating member.

Further, as illustrated in FIG. 5, an inner circumferential side portion of the upper joint sheet 61 is interposed between the lower end surface of the outflow pipe portion 36 and the upper surface of the protruding portion 56 of the bracket 54, and an outer circumferential portion of the upper joint sheet 61 is interposed between an outer circumferential portion of the lower end surface of the outflow pipe portion 36 and an outer circumferential portion of the upper end surface of the collector 37.

In the exhaust device 31, the exhaust gas flowing out of each exhaust port of the engine 21 flows into each inflow pipe portion 34 of the exhaust manifold 33, then merges at the merging portion 35, and flows into the outflow pipe portion 36 from the merging portion 35. The exhaust gas flowing into the outflow pipe portion 36 flows through the outflow pipe portion 36 and flows into the collector 37. The exhaust gas flowing into the collector 37 flows through the inside of the metal catalyst 52 of the catalyst device 51. The exhaust gas whose harmful components have been reduced by flowing through the metal catalyst 52 sequentially flows from the collector 37 through the exhaust gas lead-out hole 11 and the discharge passage, and is released into water from the release passage provided in the propeller 9.

As described above, in the exhaust device 31 of the embodiment of the present invention, the outer shell portion 53 in which the metal catalyst 52 is accommodated is provided with the bracket 54 including the protruding portion 56, and the catalyst device 51 is held in the collector 37 by the protruding portion 56 of the bracket 54 being sandwiched between the lower end portion 36A of the outflow pipe portion 36 of the exhaust manifold 33 and the upper end portion 37A of the collector 37. With this configuration, the holding force for holding the catalyst device 51 in the collector 37 can be increased as compared with a case where the catalyst device 51 is held only by being press-fitted into the collector 37 in a state in which the heat insulating material 58 is wound around the outer circumferential side of the outer shell portion 53. Therefore, the stability of holding the catalyst device 51 in the collector 37 can be improved, and the displacement of the catalyst device 51 relative to the collector 37 and the falling-off of the catalyst device 51 from the collector 37 can be prevented. Specifically, it is possible to prevent the displacement of the catalyst device 51 in the up-down direction due to the vibration of the engine 21, it is possible to prevent the falling-off of the catalyst device 51 downward from the collector 37 due to the impact generated when the ship 81 collides with the water surface during navigation, and it is possible to prevent the displacement of the catalyst device 51 in the up-down direction due to the aged deterioration of the heat insulating material 58.

In the exhaust device 31 of the present embodiment, the upper joint sheet 61 for insulating the outflow pipe portion 36 and the bracket 54 from each other is provided between the lower end surface of the outflow pipe portion 36 of the exhaust manifold 33 and the upper surface of the protruding portion 56 of the bracket 54. With this configuration, the electric corrosion of the outflow pipe portion 36 or the bracket 54 can be prevented. Therefore, it is possible to prevent the holding force for holding the catalyst device 51 between the outflow pipe portion 36 and the collector 37 from being reduced due to the electric corrosion of the outflow pipe portion 36 or the bracket 54.

Further, in the exhaust device 31 of the present embodiment, the lower joint sheet 62 for insulating the bracket 54 and the collector 37 from each other is provided between the lower surface of the protruding portion 56 of the bracket 54 and the upper end surface of the collector 37. With this configuration, the electric corrosion of the bracket 54 or the collector 37 can be prevented. Therefore, it is possible to prevent the holding force for holding the catalyst device 51 between the outflow pipe portion 36 and the collector 37 from being reduced due to the electric corrosion of the bracket 54 or the collector 37.

In the catalyst device 51 of the present embodiment, the lower end side portion of the tubular portion 55 of the bracket 54 is inserted into the outer shell portion 53 from above the outer shell portion 53 and joined to the outer shell portion 53. Accordingly, the tubular portion 55 is disposed such that the outer circumferential surface of the lower end side portion of the tubular portion 55 is in contact with the inner circumferential surface of the outer shell portion 53, and the inner circumferential surface of the lower end side portion of the tubular portion 55 is closer to the axis C of the outer shell portion 53 than the inner circumferential surface of the upper portion of the outer shell portion 53. According to this configuration, seawater or condensed water entering from the outside can be prevented from accumulating between the tubular portion 55 and the outer shell portion 53, and rust of the tubular portion 55 or the outer shell portion 53 can be prevented. If the inner diameter of the tubular portion 55 of the bracket 54 is slightly larger than the outer diameter of the outer shell portion 53 and the upper end side portion of the outer shell portion 53 is inserted into the lower end side portion of the tubular portion 55 of the bracket 54 to join the outer shell portion 53 to the tubular portion 55, seawater or condensed water is likely to accumulate on the upper end surface of the outer shell portion 53 located in the tubular portion 55. As a result, the tubular portion 55 and the outer shell portion 53 are likely to rust. According to the catalyst device 51 of the present embodiment, a portion in which seawater or condensed water is likely to accumulate is not formed between the tubular portion 55 and the outer shell portion 53, it is possible to prevent the tubular portion 55 or the outer shell portion 53 from rusting due to accumulation of seawater or condensed water.

Further, in the exhaust device 31 of the present embodiment, the enlarged diameter portion 38 whose diameter is gradually enlarged in a direction from the lower portion of the collector 37 toward the upper portion thereof is formed in the upper portion of the collector 37. With this configuration, the catalyst device 51 in which the heat insulating material 58 is wound around the outer shell portion 53 can be easily inserted into the collector 37 from above the collector 37, and the assemblability of the catalyst device 51 into the collector 37 can be improved. Specifically, a jig or the like for inserting the catalyst device 51 into the collector 37 can be eliminated, and the catalyst device 51 can be easily inserted into the collector 37 by hand. Therefore, it is possible to reduce a work load of production or maintenance of the exhaust device 31.

In the above embodiment, the case where the bracket 54 including the protruding portion 56 is joined to the outer shell portion 53 in the catalyst device 51 has been described as an example, but the present invention is not limited thereto. As illustrated in FIG. 6, a holding portion 74 having a function equivalent to that of the protruding portion 56 of the bracket 54 may be integrated with an outer shell portion 73. That is, in the catalyst device 71 illustrated in FIG. 6, the holding portion 74 is formed by bending an upper end portion (an end portion on one axial side) of the outer shell portion 73 so as to protrude radially outward. By sandwiching the holding portion 74 between the lower end portion 36A of the outflow pipe portion 36 of the exhaust manifold 33 and the upper end portion 37A of the collector 37, the catalyst device 71 can be held in the collector 37. The outer shell portion 73 integrated with the holding portion 74 can be formed by, for example, drawing or the like.

In the above embodiment, the case where the protruding portion 56 of the bracket 54 of the catalyst device 51 is sandwiched between the exhaust manifold 33 and the collector 37 has been described as an example, and the present invention is not limited thereto. The protruding portion 56 may be sandwiched between the exhaust manifold and an exhaust pipe other than the collector, which constitutes the exhaust passage of the exhaust device. The protruding portion 56 may be sandwiched between the collector and an exhaust pipe other than the exhaust manifold, which constitutes the exhaust passage of the exhaust device. Alternatively, the protruding portion 56 may be sandwiched between two exhaust pipes that constitute the exhaust passage of the exhaust device and are not the exhaust manifold or the collector. In addition, the protruding portion 56 may be sandwiched between an exhaust pipe constituting the exhaust passage of the exhaust device and a component corresponding to the exhaust pipe.

In the above embodiment, the case where the catalyst device 51 is disposed in the collector 37 has been described as an example, but the present invention is not limited thereto. For example, the catalyst device 51 may be disposed in the outflow pipe portion 36 of the exhaust manifold 33 such that a portion of the catalyst device 51 other than the metal catalyst 52 is turned upside down from the above-described embodiment.

Further, in a case where there is no possibility of exhaust gas leakage from the exhaust passage 32, the exhaust manifold 33 and the bracket 54 of the catalyst device 51 are formed of the same kind of metal, and electric corrosion does not occur or hardly occurs even when the exhaust manifold 33 and the bracket 54 come into contact with each other, the upper joint sheet 61 may not be provided. Similarly, in a case where the bracket 54 of the catalyst device 51 and the collector 37 are formed of the same kind of metal and electric corrosion does not occur or hardly occurs even when the bracket 54 and the collector 37 come into contact with each other, the lower joint sheet 62 may not be provided. However, in a case where the exhaust manifold 33 and the collector 37 are formed of different kinds of metals, a sheet formed of an insulating material is provided between the outflow pipe portion 36 of the exhaust manifold 33 and the collector 37.

The material of the exhaust manifold 33, the material of the collector 37, and the materials of the outer shell portion 53 and the bracket 54 of the catalytic device 51 are not limited to those in the above-described embodiment.

Further, the exhaust device 31 of the above embodiment is disposed on the left side of the engine 21. Alternatively, the exhaust device of the present invention may be disposed at another location of the engine, such as on the right side of the engine. The number of cylinders in the engine is not limited. The present invention is not limited to the exhaust device of the outboard motor, and may be applied to an exhaust device of another type of ship propulsion machine such as an inboard/outboard motor or an inboard motor.

The present invention can be modified as appropriate without departing from the scope or spirit of the invention which can be read from the claims and the entire description, and the exhaust device accompanying such a change is also included in the technical concept of the present invention.

What is claimed is:

1. An exhaust device configured to discharge exhaust gas from an engine of a ship propulsion machine, the exhaust device comprising:
an exhaust passage through which the exhaust gas flows; and
a catalyst device provided in the exhaust passage and configured to purify the exhaust gas,
wherein the exhaust passage includes
a first exhaust pipe, and
a second exhaust pipe connected to an outflow side of the first exhaust pipe,
wherein the catalyst device includes
a metal catalyst including a catalyst carrier made of a metal,
an outer shell portion having a tubular shape and accommodating the metal catalyst therein, and
a holding portion provided in the outer shell portion, having a brim shape protruding radially outward beyond an outer circumferential surface of the outer shell portion, and configured to hold the catalyst device in the exhaust passage, and
wherein the catalyst device is held in the exhaust passage by the holding portion being sandwiched between an outflow-side end portion of the first exhaust pipe and an inflow-side end portion of the second exhaust pipe.

2. The exhaust device according to claim 1,
wherein a first insulating member configured to insulate the first exhaust pipe and the holding portion from each other is provided between the first exhaust pipe and the holding portion.

3. The exhaust device according to claim 1,
wherein a second insulating member configured to insulate the second exhaust pipe and the holding portion from each other is provided between the second exhaust pipe and the holding portion.

4. The exhaust device according to claim 1,
wherein the holding portion includes
a tubular portion, and
a protruding portion protruding radially outward from a portion on one axial end side of the tubular portion, and
wherein a portion on the other axial end side of the tubular portion is inserted into the outer shell portion from the inflow side of the outer shell portion and joined to the outer shell portion, and an inner circumferential surface of the portion on the other axial end side of the tubular portion is closer to an axis of the outer shell portion than an inner circumferential surface of an inflow side portion of the outer shell portion.

5. The exhaust device according to claim 1,
wherein the holding portion is formed by bending an end portion on an axial side of the outer shell portion so as to protrude radially outward.

6. The exhaust device according to claim 1,
wherein the catalyst device is disposed in the second exhaust pipe,
wherein a heat insulating material is provided between the outer shell portion and the second exhaust pipe, and
wherein an enlarged diameter portion is provided in a portion on one axial side of the second exhaust pipe, the enlarged diameter portion being gradually enlarged in diameter in a direction from the other axial side of the second exhaust pipe toward one axial side in order to insert the catalyst device and the heat insulating material into the second exhaust pipe from the one axial side of the second exhaust pipe.
